(19) United States
(12) Patent Application Publication
(10) Pub. No.: US 2006/0236948 A1
(43) Pub. Date: Oct. 26, 2006

(54) Self replenishing pet water bowl

(76) Inventor: Lawrence I. Wechsler, Great Neck, NY (US)

Correspondence Address: Lawrence I. Wechsler, One Wooleys Lane, Great Neck, NY, 11023, US

(21) Appl. No.: 11/359,986

(22) Filed: Feb. 21, 2006

Related U.S. Application Data
(60) Provisional application No. 60/654,142, filed on Feb. 18, 2005.

(51) Int. Cl. A01K 7/00

(52) U.S. Cl. 119/77

(57) ABSTRACT

A self replenishing animal feeding bowl includes a trough defining a bowl portion and a feed containing reservoir engageable in feed supply communication therewith. The reservoir can be selectably sealable, by provision of a cap or valve, such that feed contents can be retained in the reservoir when inverted, with an opening thereof in a lower position than at least a portion of the contents, when removed from or installed to the bowl portion during refilling. When installed to the bowl during active feeding, the reservoir can be likewise selectively opened to allow free release of the contents to the trough of the bowl for consumption by the pet. Alternatively, or in combination with the sealable feature, an axis of the reservoir passing through a base and the outlet of the reservoir is oriented at an angle which is tilted relative to true vertical.

### CROSS REFERENCE TO RELATED APPLICATIONS

This application claims the benefit of U.S. Provisional Application No. 60/654,142 filed Feb. 18, 2005 entitled SELF REPLENISHING PET WATER BOWL.

### BACKGROUND OF THE INVENTION

The present invention relates to a water bowl for pets, and more particularly, to a water bowl of the type in which available water in the bowl is replenished from a supply reservoir as and when water in the bowl is consumed by the pet.

Self replenishing bowls of the type mentioned above are well known, and generally comprise a bowl portion presenting an open top, relatively shallow trough and a water supply in the form of an inverted reservoir in communication with the bowl portion. In such devices, an outlet of the reservoir extends below an upper edge of the trough, such that the atmospheric pressure exerted on the water in the open top trough operates to prevent release of water from the supply reservoir which would raise the level of water in the trough to greater than the height of the opening of the reservoir which extends just below a surface of the water in the bowl. As water is consumed to a level below the reservoir opening, water is replenished from the reservoir until the water in the bowl rises to a height just cover the opening.

While operating quite well, such devices nevertheless have a drawback residing in the limitations and difficulties attendant replacement of the water-filled reservoir, as needed. In this regard, the reservoir, being open at all times, does not lend itself to removal and refilling until completely exhausted of contents. Furthermore, when filled and ready for installation to the bowl portion, either the entire bowl must be inverted, attached to the bottle, and the combination then turned over together, or, alternatively the bottle must be quickly and adeptly inverted and inserted into secure engagement with the bowl portion before excessive spillage occurs, much in the all too familiar manner of replacement of a water jug on an office cooler.

A further drawback of the conventional self replenishing bowls described above is the unappealing, utilitarian form of an inverted bottle extending above the bowl and, additionally, the inherent top-heaviness when filled, which makes the units potentially prone to tipping over, resulting, for example, from the influences of an overly eager dog or other pet.

It would therefore be desirable to provide a water (or any other flowable feed material) bowl of the self replenishing type which permits facilitated replacement of the water supply, even when still partially full, and which is embodied in an attractive and stable physical form.

Accordingly, it is an object of the invention to provide a self replenishing bowl device which overcomes the drawbacks of the prior art.

It is a further object of the invention to provide an animal bowl in a form which is attractive, stable and reliable, and which allows convenient and versatile refilling operations.

It is an additional object to provide a bowl device in a form that is economical and simple in construction.

### SUMMARY OF THE INVENTION

In accordance with these and other objects of the invention, there is provided a self replenishing animal bowl device which includes a base defining a bowl portion including an open top trough and a feed containing reservoir engageable in feed supply communication therewith. For purposes herein, the term “feed” is defined to broadly include water, as well as nutritive consumables (flowable solid or liquid). In addition, the disclosures herein describing functioning of the invention relative to water are likewise intended to extend to any suitable flowable substance.

In accordance with an optional feature of the invention, flow from an outlet of the reservoir can advantageously be selectively restricted, for example, by provision of a cap or valve, such that contents can, at least to a meaningful degree, be retained in the reservoir when the reservoir is inverted with an opening thereof in a lower position than at least a portion of the contents, for example, when removed from or installed to the bowl during refilling. When installed to the bowl during active feeding, the reservoir can be likewise selectively opened (the restriction relieved) to allow the contents to be readily released to the trough of the bowl for consumption by the pet. When so opened, the device operates in an analogous manner with the conventional self replenishing bowls described above herein.

Another feature of the invention, which optionally can be employed either apart from the aforementioned feature directed to selective restriction of flow or in combination therewith, is to orient the reservoir in a tilted state relative to true vertical. Such provision facilitates configuring the reservoir in a form having a lower profile for greater stability when installed to the bowl portion, and further allows the outlet of the reservoir to be disposed adjacent to the trough of the bowl portion such that contents in the reservoir flows directly into the trough. Furthermore, when selective restriction of the outlet is not practiced in conjunction with the tilted feature, the reservoir is more quickly and readily returned to an upright position and vice versa, resulting in reduced spillage during refilling operations.

According to an embodiment of the invention, a device includes a base comprising a bowl portion defined by a trough and a support portion laterally adjacent thereto, and a cover engageable with the base and configured to at least partially enclose the region immediately above the support portion when in closed engagement to the base. A reservoir is provided which includes an outlet opening at a top thereof, the reservoir being supportably receivable on the support portion of the base such that the reservoir, from base to opening, advantageously extends at a tilted angle relative to true vertical. The cover is movable from the closed engagement condition with the base to a position allowing user access to the reservoir, either by complete removal therefrom or by positional reorientation.

Advantageously, the reservoir is selectively openable and closable by provision of a valve, which optionally (and more advantageously) is automatically actuated (opened) and closed, respectively, by installation and removal from an installed condition to the base. To this end, conveniently, the valve is spring biased in a sealed position, and a stop provided, for example, on the base which causes the valve mechanism to be moved against the biasing to an open position when the reservoir is placed in supported, installed engagement with the base. It is noted that the terms “closable” and “close,” in the context of this disclosure when referring to the operation of a valve or other mechanism for restricting flow, are intended as relative terms, and selective closure, as defined herein, need not provide an absolute seal against flow from the outlet of the reservoir. Rather, selective closure of the outlet, as described herein, includes any inhibition of flow ordinarily experienced when the outlet is fully open.

The above, and other objects, features and advantages of the present invention will become apparent from the following description read in conjunction with the accompanying drawings.

### BRIEF DESCRIPTION OF THE DRAWINGS

FIG. 1 is a cross-sectional side elevation of a water bowl device according to an embodiment of the invention, depicted in a use orientation;

FIG. 2 is a cross-sectional end view of the water bowl device of FIG. 1;

FIG. 3 is a perspective view of the water bowl device of FIGS. 1 and 2;

FIG. 4a is a cross-sectional detail view of an automatic valve optionally used for selective sealing of the reservoir shown in a sealed position;

FIG. 4b is a cross-sectional detail view of the automatic valve of FIG. 4a shown in an open position; and

FIG. 5 is an end view of the movable valve element of the automatic valve of FIGS. 4a and 4b.

### DETAILED DESCRIPTION OF THE PREFERRED EMBODIMENT

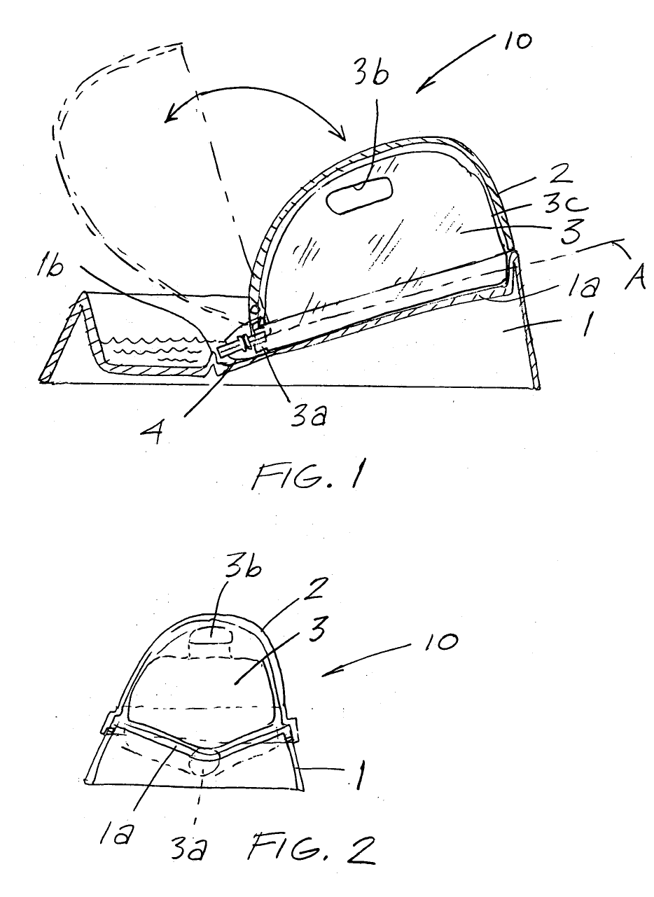

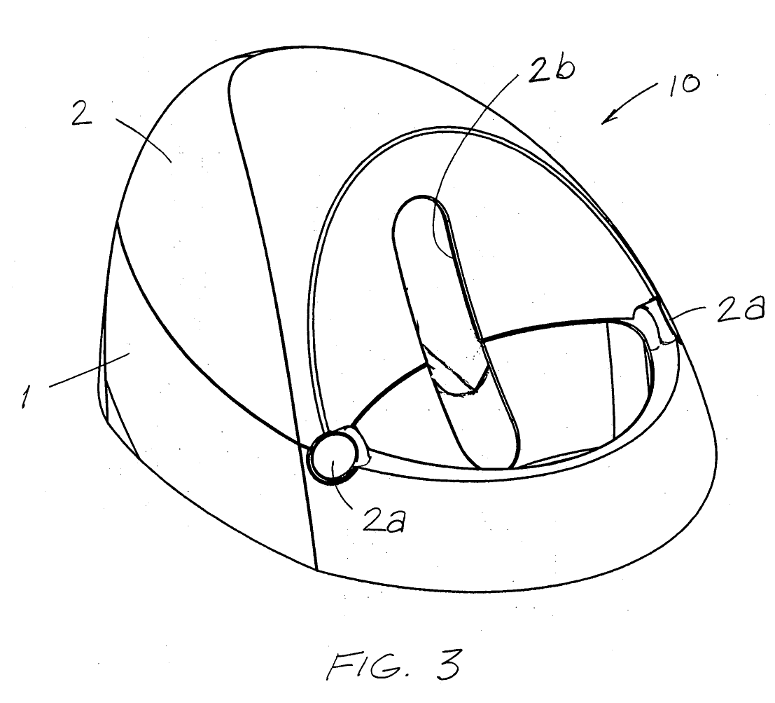

Referring now to the figures, and in particular FIGS. 1-3, a self replenishing animal bowl device in accordance with an embodiment of the invention is shown, generally at 10. Bowl device 10 includes a base 1, a reservoir 3, and advantageously, also, a cover 2. Cover 2 is optionally hinged to the base 1 (via hinges 2a shown in FIG. 3), permitting, for example, cover 2 to pivot forward, from a closed to open position, as shown for example in FIG. 1 (movement as indicated by the curved arrow). When cover is opened, access to the reservoir 3 is provided, permitting removal of same for refilling and replacement. As best seen in FIG. 2, base 1 includes a support portion 1a on which the reservoir 3 rests when installed. The support portion 1a and the reservoir 3 are advantageously conformably configured with a keel (conveniently of roughly V shape as shown in FIG. 2), such that water (or other feed) in the reservoir 3 is centrally directed to an outlet 3a of the reservoir 3, and additionally, to self center the reservoir 3 when reservoir 3 is supportably received to the base 1. Additionally, support portion 1a advantageously has an irregular upper surface, presenting for example, a series of raised ribs or bumps, such that when reservoir 3 is installed thereto, any water on such surface will be able to escape between the ribs and be guided into the trough of base 2, and will not be pushed up over the outermost edges of the support portion 1a and onto the floor. Reservoir 3 also advantageously (optionally) includes a handle 3b to facilitate handling thereof.

In the depicted example, reservoir 3 is advantageously, though not necessarily, oriented such that an axis A passing from a base 3c of reservoir 3 through the outlet 3a is arranged at an angle relative to true vertical, such that the reservoir is oriented in a tilted position rather than being fully upright and inverted. By suitable configuration of the reservoir 3, such feature can provide more stability by reducing the height of the reservoir 3 above the base. Also, as seen in FIG. 3 (in which depiction of the reservoir 3 is omitted), cover 2 advantageously (optionally) includes a vertical cutout 2b (or window) through which a portion of reservoir 3 either protrudes, or is at least visible therethrough, to allow monitoring of a feed level therewithin.

A provision for selectively inhibiting flow of contents from the reservoir 3 and permitting flow therefrom, for respective maintenance and active use operations, is optionally provided at the outlet 3a. Many suitable structures can be used to achieve this selective control of flow through the outlet 3a of the reservoir 3, including any number of cap arrangements (removable or captive) which are configured to selectively engage structure of the reservoir 3 in a manner inhibiting a flow of contents therefrom, as well as any number of valves (both absolute closure type and regulatory). If so desired, the outlet 3a could also be configured to allow a finger of the user to cap the outlet 3a to provide the selective restriction and opening.

Use of a valve of the type that is responsive to the particular operation being performed, such that the valve is appropriately operational for respectively permitting and inhibiting flow, is deemed particularly advantageous. For example, as shown in the figures, a valve 4 is optionally received to the opening 3a of the reservoir 3 (for example by threaded engagement), and is configured to be automatically actuated by installed receipt of the reservoir 3 to the base 1. A stop 1b carried in suitable position on the base 1 conveniently serves to urge the valve from an inhibitory position to an opened position, as will be explained in greater detail below.

Before proceeding further with the description of the figures, it is noted that the above embodiment serves merely as a preferred example of the many possible embodiments of the invention, and many of the features included therein, while deemed advantageous to practice of the invention on a commercial level, and as discussed above, are not essential to the invention as broadly contemplated. Therefore, it will be understood that numerous other embodiments are envisioned which can make use of various sub-combinations of the elements described with regard to the illustrated embodiment. For example, the cover 2, rather than being hinged to the base 1, could be removable from, and replaceable to, the base, or omitted entirely.

It is further noted that the placement and arrangement of the various component elements is likewise not essential to practice of the invention. For example, rather that pivoting forward, cover 2 could be appropriately mounted to pivot to a side or backward of the base 1.

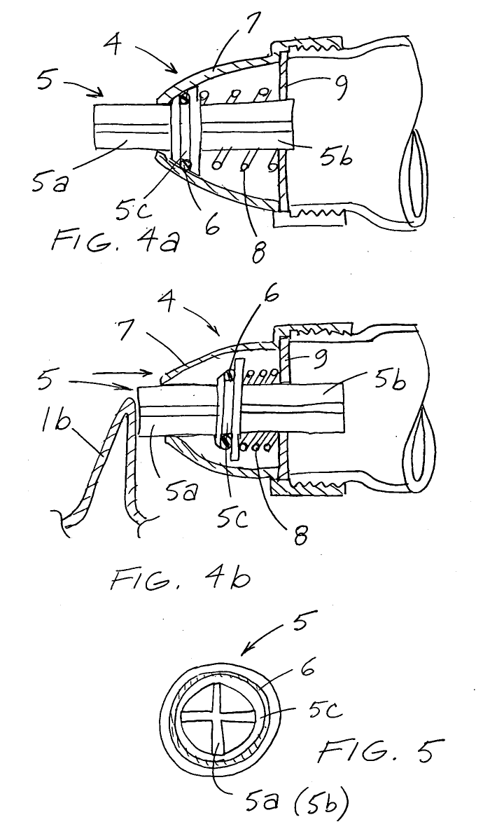

Turning now to FIGS. 4a and 4b, the details of valve 4 included advantageously in the embodiment of FIGS. 1-3 are shown in lateral cross-section. Valve 4 includes a movable valve element 5 comprised of front and rear cross member portions 5a and 5b, and a channel portion 5c in which an o-ring 6 is received. The movable valve element 5 is slidable from a closed position (FIG. 4a) to an open position (FIG. 4b), and is guided within a nozzle 7 and a retainer ring 9 fixed thereto. A spring 8 captively retained between the movable valve element 5 and the retainer ring 9 biases the movable valve element 5 into the closed position of FIG. 4a in which the o-ring seals 6 against an interior of the nozzle 7. When the reservoir is installed to the base 1, the movable valve element 5 is urged backwards by suitably positioned stop 1b formed in base 1 to the valve-open position shown in FIG. 4b, thereby initiating flow into the open top trough of the base 1.

FIG. 5 details the movable valve element 5, illustrating a suitable X-shaped cross-section of cross member portions 5a and 5b. Alternative to such cross-sectional shape, a Y-shaped or other suitable cross-section allowing flow of contents therepast while concomitantly advantageously guidably centering the movable valve element 5 by slidable contact thereof with a hole of corresponding size in nozzle 7 and retainer ring 9, can be adopted.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

What is claimed is:

1. A self replenishing feed bowl, comprising:
a base including an open top trough portion defining an interior region in which feed material can pool;
a reservoir having an outlet which can be brought into feed communication with the interior region of the trough portion allowing transfer of the feed material from the reservoir to the open top trough, the outlet of the reservoir being selectively sealable.

2. A self replenishing fed bowl according to claim 1, wherein an axis of said reservoir passing through a base of said reservoir and said outlet of said reservoir is oriented at an angle which is tilted relative to true vertical.

3. A self replenishing feed bowl according to claim 1, wherein said base include a support portion on which said reservoir is restable, said support portion and said reservoir being generally conformably configured with a keel such that the feed material water in the reservoir is centrally directed to said outlet of the reservoir and that the reservoir is self centered when supportably received to the base on said support portion.

4. A self replenishing fed bowl according to claim 1, further comprising a cover engageable with the base and configured to at least partially enclose the region immediately above the support portion when in closed engagement to the base.

5. A self replenishing fed bowl according to claim 1, further comprising a valve was is automatically actuated and closed, respectively, by installation to and removal from an installed condition to the base.

6. A method of introducing feed into a bowl for animal consumption, comprising:
bring an outlet of a reservoir in communication with a trough such that contents of the reservoir is transferable to the trough; and
orienting an axis of said reservoir passing through a base of said reservoir and said outlet of said reservoir at an angle which is tilted relative to true vertical.

7. A method according to claim 6, further comprising:
selectively restricting the outlet of the reservoir to inhibit flow of contents therefrom to allow removal and replacement of the reservoir from a mounted orientation without excessive loss of the contents;
replacing the reservoir to the mounted orientation following refilling of the reservoir; and
selectively opening the outlet to allow flow of the contents into the trough.

8. A method of introducing feed into a bowl for animal consumption, comprising:
disposing a reservoir with an outlet of the reservoir in communication with the trough such that contents of the reservoir is transferable to the trough;
selectively restricting the outlet of the reservoir to inhibit flow of contents therefrom to allow removal and replacement of the reservoir from a mounted orientation without excessive loss of the contents;
replacing the reservoir to the mounted orientation following refilling of the reservoir; and
selectively opening the outlet to allow flow of the contents into the trough.

9. A method according to claim 4, wherein
said step of selectively restricting is automatically initiated in response to removal of the reservoir from the mounted orientation; and
said step of selectively opening the outlet is automatically initiated in response to said step of replacing.
